(19) United States
(12) Patent Application Publication
(10) Pub. No.: US 2004/0121118 A1
(43) Pub. Date: Jun. 24, 2004

(54) Space-enclosing panel

(75) Inventors: Klaus Bertermann, Kosterbeck (DE); Ulf Fellmann, Rostock (DE)

Correspondence Address: BROWDY AND NEIMARK, P.L.L.C., 624 NINTH STREET, NW, SUITE 300, WASHINGTON, DC, 20001-5303, US

(73) Assignee: Rheinhold & Mahla Aktiengesellschaft, Munchen (DE)

(21) Appl. No.: 10/733,240

(22) Filed: Dec. 12, 2003

(30) Foreign Application Priority Data
Dec. 12, 2002 (DE) 102 57 977.6

(51) Int. Cl. B32B 3/04

(52) U.S. Cl. 428/121

(57) ABSTRACT

A space-enclosing panel comprises at least one slab of mineral wool, at least one of the two principal outsides of which is provided with a cover, with the slab of mineral wool being comprised of fibers that extend crosswise of the principal outside. The fibers run on, and substantially parallel to, a plane that is parallel to a principal outside.

### BACKGROUND OF THE INVENTION

1. Field of the Invention

The invention relates to a space-enclosing panel, comprising at least one slab of mineral wool, at least one of two principal outsides thereof being provided with a cover, with the slab of mineral wool being comprised of fibers that extend crosswise of the principal outside.

2. Background Art

Panels of the generic type have a supporting core which consists of a slab of mineral wool, one outside or both outsides of which being provided with a non-inflammable cover for instance of sheet metal. Mineral wool is not inflammable by nature. Depending on the type of use as a wall, ceiling or floor panel, the covers are provided with varying folds.

The slabs of mineral wool may consist of fibers that extend parallel to the principal outside i.e., parallel to the principal plane of the slab. In this case, the panels have comparatively high sound proofing values. By contrast, the rigidity of the panels is lower. “Conrock” is a registered trademark for the protection of slabs of mineral wool that are folded from continuous mats of mineral wool. The areas in the vicinity of the folding are ground off prior to the mats being processed into the panels of the species. Then the covers are attached to these ground surfaces. As compared to the panels described above, these panels excel by increased rigidity, having however decreased sound proofing values.

### SUMMARY OF THE INVENTION

It is an object of the invention, to embody a space-enclosing panel that exhibits high rigidity on the one hand and satisfying sound proofing values on the other without any increase in manufacturing requirements.

According to the invention, this object is attained in a space-enclosing panel of the generic type by the fibers running on, and substantially parallel to, at least one plane that is parallel to a principal outside. The gist of the invention resides in that the areas, which form in the vicinity of the folds upon manufacture by the mats of mineral wool being folded into slabs of mineral wool, are maintained at least on one outside of the slab of mineral wool.

Further features, advantages and details of the invention will become apparent from the ensuing description of exemplary embodiments of the invention.

### BRIEF DESCRIPTION OF THE DRAWING

FIG. 1 is an illustration of a floor panel according to the invention;

FIG. 2 is an illustration of several floor panels placed side by side to form a floor;

FIG. 3 is an illustration of a wall panel of sandwich design;

FIG. 4 is an illustration of another wall panel of sandwich design;

FIG. 5 is a ceiling panel of one-cover design; and

FIG. 6 a ceiling panel of sandwich design.

### DESCRIPTION OF PREFERRED EMBODIMENTS

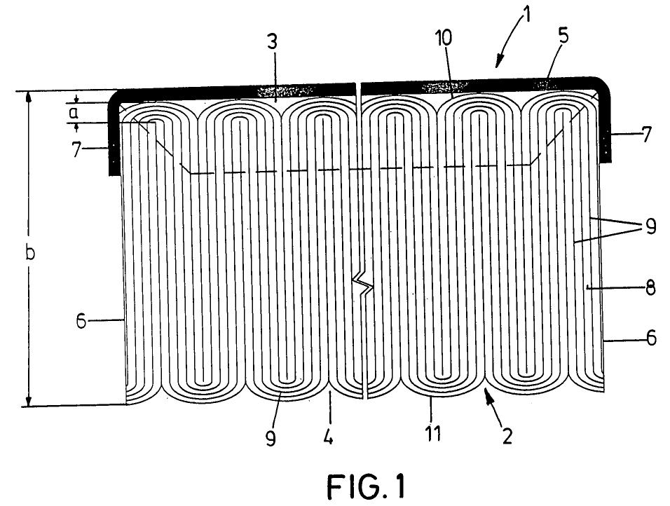

As seen in FIG. 1, the floor panel 1 there illustrated comprises a slab of mineral wool 2 as a supporting core, which has two parallel principal outsides 3, 4. A cover 5, formed by a comparatively thick metal sheet, is attached to the principal outside 3 that is at the top after placement, serving as a layer on which to step after the panel 1 has been placed. The sheet that constitutes the cover 5 is folded in the vicinity of the sides 6 of the slab 2, forming rims 7.

As seen in FIG. 1, the slab of mineral wool 2 is formed by a long or continuous mat of mineral wool 8 which is folded in the vicinity of the principal outsides 3, 4. Inside the slab of mineral wool 2, the fibers 9 that run in the longitudinal direction of the mat 8 are perpendicular to the principal outsides 3, 4 and thus to the cover 5, while being substantially parallel to the principal outsides 3, 4 and thus to the cover 5 in the external areas of deflection 10, 11 formed by the folds.

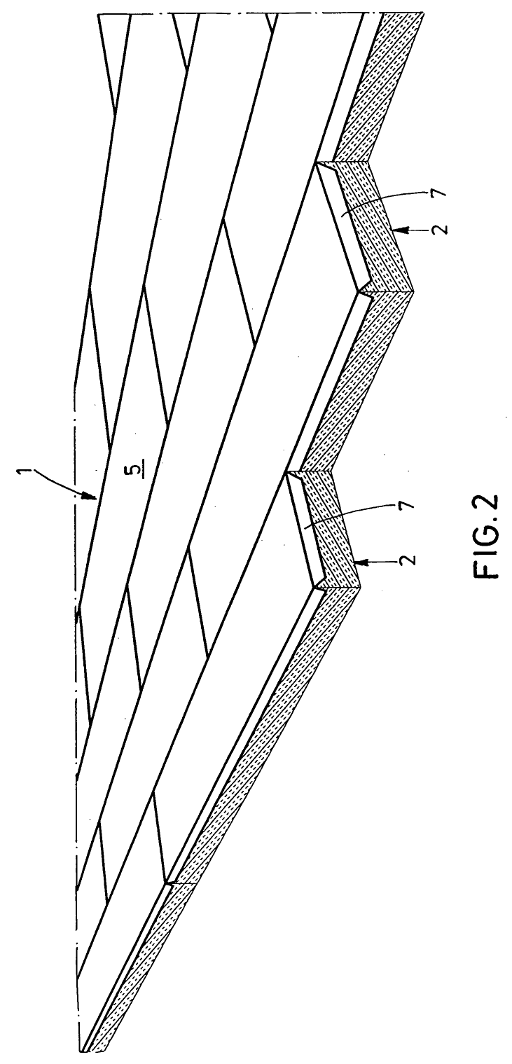

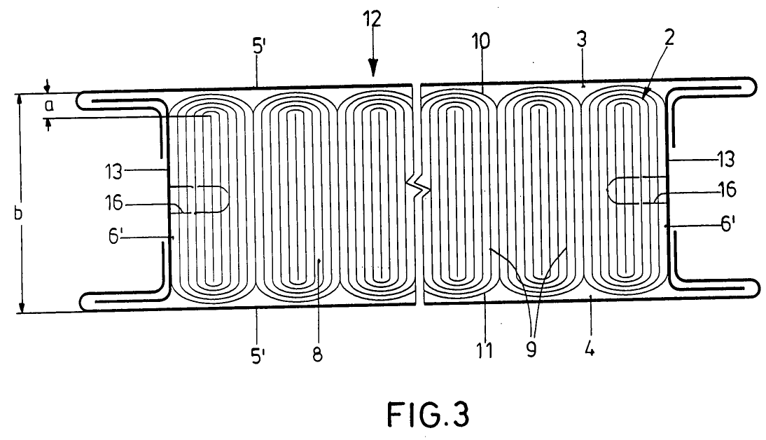

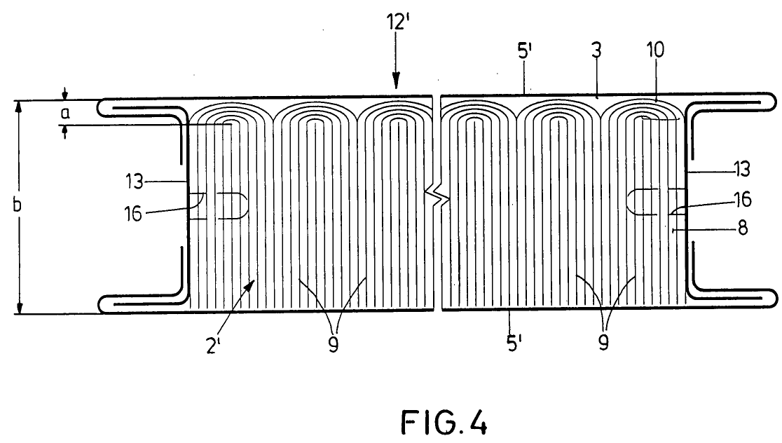

FIG. 2 illustrates how these floor panels 1 are placed tightly side by side so that the covers 5 constitute a coherent surface on which to step.

The wall panel 12 seen in FIG. 3 has a slab of mineral wool 2 as a supporting core, corresponding to that of FIG. 1. As for the structure, reference is made to the foregoing explanations. It comprises two covers 5′ which are folded around a sectional strip 13 in the shape of a C that covers the respective side 6′. Fundamentally, each cover 5′ may serve as the fair-faced cover. The sectional strip 13 is provided with ribs 16 which are formed by the sectional strip 13 being partially punched and bent, projecting from the strip 13 inwards into the slab 2. These ribs 16 serve for fixing the sectional strip 13 and the slab 2 relative to each other.

The wall panel 12′ of FIG. 4 differs from that according to FIG. 3 only in that the slab of mineral wool 2′ comprises the areas of deflection and thus fibers 9, which are substantially parallel to the cover 5′, only in the vicinity of one principal outside 3. In the vicinity of the cover 5′ at the bottom in the drawing, these areas of deflection have been ground off so that the fibers 9 are directly perpendicular to the cover 5′.

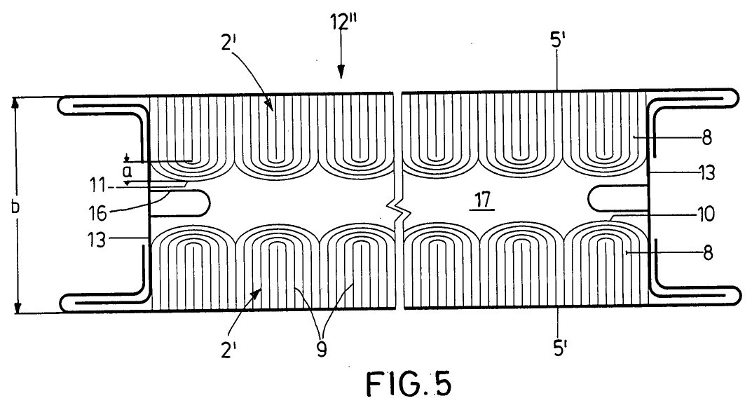

The wall panel 12″ of FIG. 5 differs from the above wall panels in that two slabs of mineral wool 2′ and 2′ are disposed between the covers 5′, the areas of deflection of which being ground off unilaterally, namely on the side where the respective slab of mineral wool 2′ and 2′ contacts the cover 5′. The remaining areas of deflection 10, 11 lie centrally between the slabs 2′, 2′, between them defining an air gap 17 for increased insulation. They may also adjoin each other.

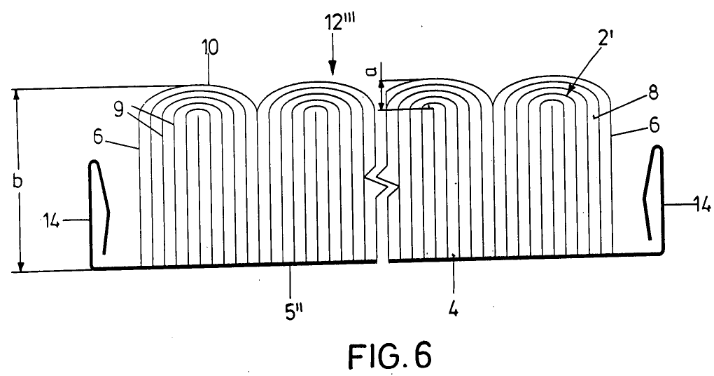

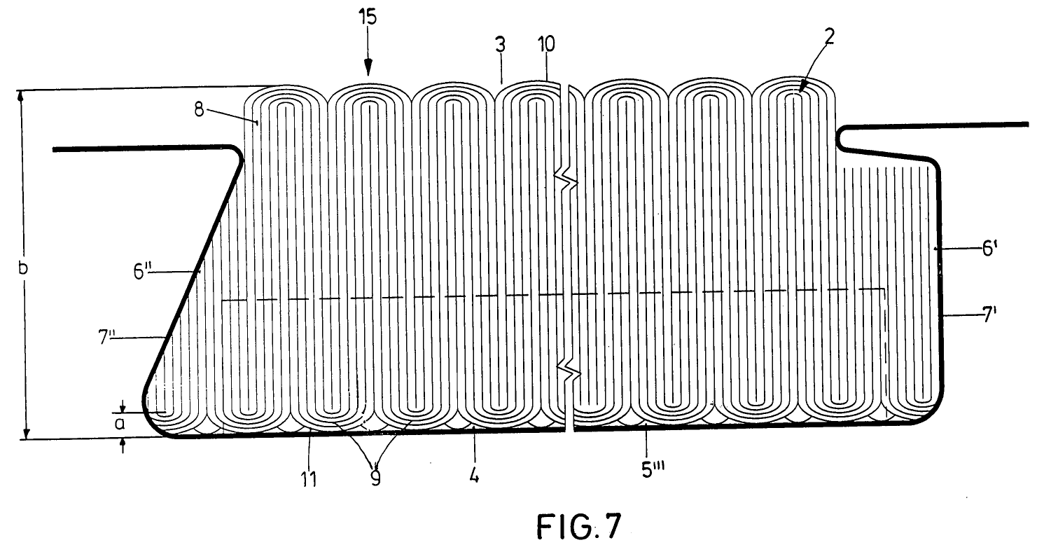

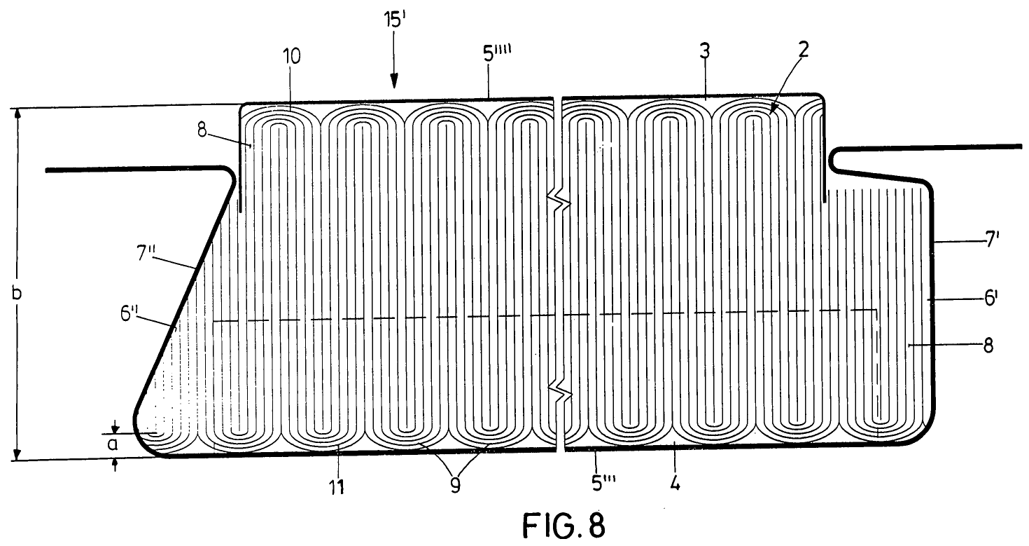

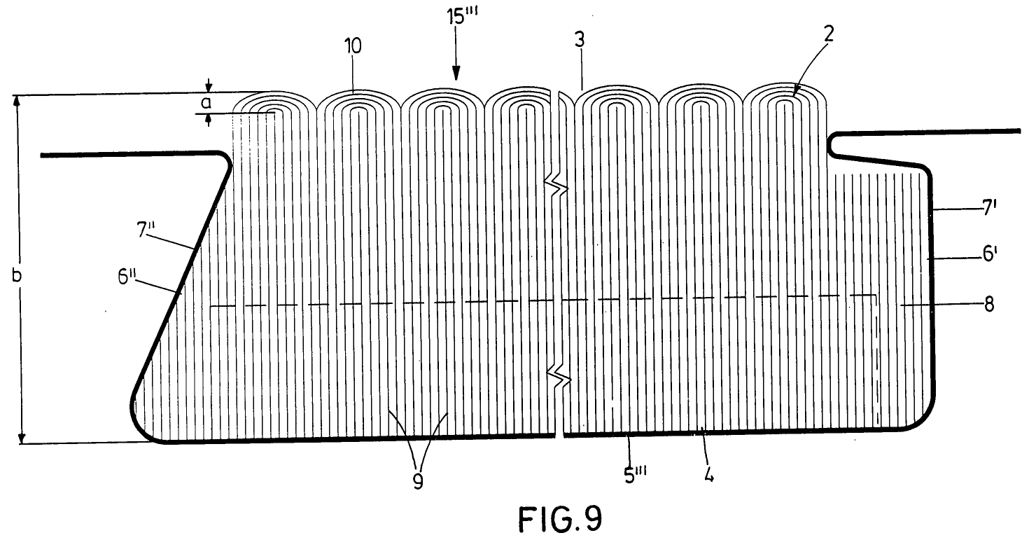

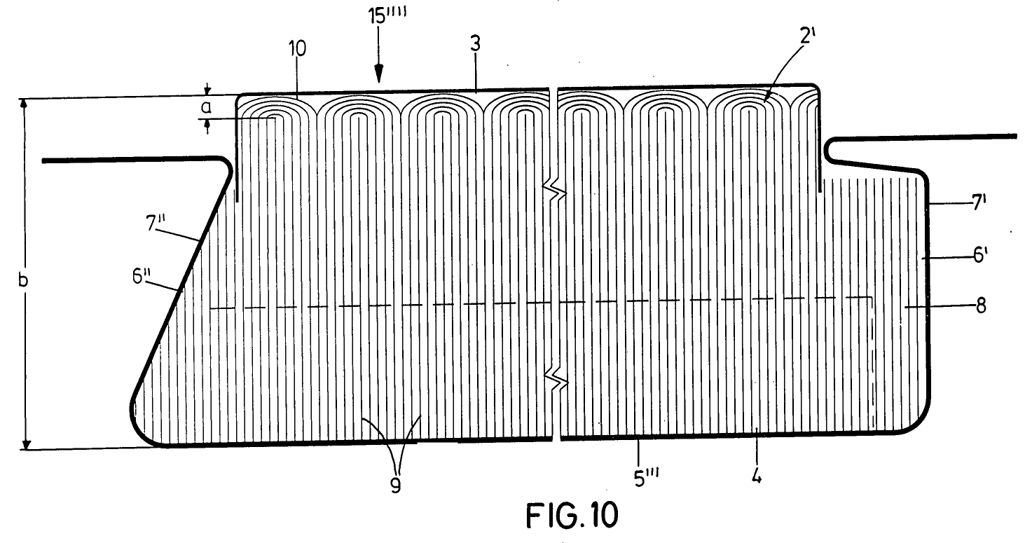

The wall panel 12′″ of FIG. 6 is a one-cover panel. It comprises a slab of mineral wool 2′, the areas of deflection 10 of which are not provided with a cover. Such a cover 5″ with folded rims 14 is only attached to the principal outside 4 where the area of deflection, which is formed by the fold of the mat of mineral wool 8, has been ground off.

The ceiling panel 15 of FIG. 7 comprises a slab of mineral wool 2 as specified among others in connection with FIG. 1. The panel 15 is a one-cover panel i.e., only the bottom that serves as an appearance side is provided with a cover 5′″ which, on the partially recessed sides 6′, 6″, is folded to form rims 7′, 7″. The principal outside 4, which faces the cover 5′″, and the principal outside 3 at the top, which is not visible after installation, exhibit the areas of deflection 10, 11 formed by the folds of the mat of mineral wool 8 where the fibers 9 are substantially parallel to the respective principal outside 3 and 4.

The ceiling panel 15′ according to FIG. 8 differs from that of FIG. 7 only by its sandwich design i.e., also the principal outside 3 at the top of the slab of mineral wool 2 is covered by a folded sheet as a top cover 5″″ which engages with the rims 7′, 7″ of the bottom cover 5′″.

The ceiling panels 15′″ of FIGS. 9 and 15″″ of FIG. 10 differ from those according to FIGS. 7 and 8 only in that the slabs of mineral wool 2′ do not possess any areas of deflection of the mats of mineral wool 8 and consequently no fibers 9 on the side turned towards the cover 5′″. These areas of deflection are ground off there too so that the fibers 9 directly bear against the cover 5′″.

In practice, the thickness a of the areas of deflection 10 and 11 ranges from 5 to 25 percent of the total thickness b of a panel.

The slabs of mineral wool 2, 2′ are always glued to the cover 5, 5′, 5″, 5′″,

What is claimed is:

1. A space-enclosing panel, comprising at least one slab of mineral wool (2, 2′), at least one of two principal outsides (3, 4) thereof being provided with a cover (5, 5′, 5″, 5′″, 5″″), with the slab of mineral wool (2, 2′) being comprised of fibers (9) that extend crosswise of the principal outside (3, 4), wherein the fibers (9) run on, and substantially parallel to, at least one plane that is parallel to a principal outside (3, 4).

2. A space-enclosing panel according to claim 1, wherein the slab of mineral wool (2, 2′) is comprised of at least one mat of mineral wool (8) which is folded into folds, with areas of deflection (10, 11) being formed at the folds and constituted by the fibers (9) that extend approximately parallel to the plane.

3. A space-enclosing panel according to claim 2, wherein an area of deflection (10, 11) is provided only on one principal outside (3, 4).

4. A space-enclosing panel according to claim 2, wherein one area of deflection (10, 11) is provided on each of the two principal outsides (3, 4).

5. A space-enclosing panel according to claim 2, wherein two slabs of mineral wool (2′, 2′) rest on each other by their areas of deflection (10, 11).

6. A space-enclosing panel according to claim 1, wherein a cover (5, 5″, 5′″) is allocated to only one principal outside (3, 4).

7. A space-enclosing panel according to claim 1, wherein a cover (5′, 5″, 5″″) is allocated to each of the two principal outsides (3, 4).

8. A space-enclosing panel according to claim 1, wherein the thickness (a) of the areas of deflection (10, 11) ranges from 5 percent to 25 percent of the total thickness (b) of a panel.
